(19) United States
(12) Patent Application Publication
(10) Pub. No.: US 2021/0053874 A1
(43) Pub. Date: Feb. 25, 2021

(54) DELAYED-EXPANSION CEMENT AND CEMENTING OPERATIONS

(71) Applicant: SCHLUMBERGER TECHNOLOGY CORPORATION, Sugar Land, TX (US)

(72) Inventor: Nicolas DROGER, Clamart (FR)

(21) Appl. No.: 16/077,174

(22) PCT Filed: Feb. 11, 2016
(86) PCT No.: PCT/IB2016/000261

§ 371 Date: Aug. 10, 2018

(51) Int. Cl. C04B 20/10; C09K 8/493

(52) U.S. Cl. CPC C04B 20/1051; C04B 2103/0052; C09K 8/493; C04B 20/1062

(57) ABSTRACT

A delayed-expansion cement mixture or slurry of hydraulic cement contains an expanding agent having hydrophobically modified surfaces with a hydrophobic and/or self-assembling film. A method to delay expansion of cement involves treating the expanding agent with a self-assembling film precursor compound, making the slurry with cement and water, and setting and expanding the cement. A cementing method places the mixture or slurry downhole where it is hardened and expanded.

### BACKGROUND

The statements in this section merely provide background information related to the present disclosure and may not constitute prior art.

The present disclosure broadly relates to cement and cementing operations.

Hydraulic cement is any substance provided (at least at one time in the manufacturing process) in a powdered or granular form, that when mixed with a suitable amount of water, can form a paste that can be poured or molded to set as a solid mass. In the oil and gas industry, good bonding between set cement and casing, and also between set cement and the formation, are essential for effective zonal isolation. Poor bonding limits production and reduces the effectiveness of stimulation treatments. Communication between zones can be caused by inadequate mud removal, poor cement/formation bonding, expansion and contraction of the casing resulting from internal pressure variations or thermal stresses, and cement contamination by drilling or formation fluids. Under such circumstances a small gap or microannulus may form at the cement/casing or the cement/formation interface, or both.

The addition of charcoal with wood resin-coated aluminum particles for an expansive cement is disclosed in U.S. Pat. Nos. 4,332,619 and 4,328,038. The use of encapsulated gas and other expanding fluids is also disclosed in U.S. Pat. Nos. 7,494,544 and 7,156,174.

Portland cement manufacturers have employed shrinkage-compensating cements that include an offsetting “expansive cement”, which is a cement that when mixed with water forms a paste that, after setting, tends to increase in volume to significantly greater degree than Portland cement paste, in accordance with American Concrete Institute 223R-10 Guide for the Use of Shrinkage-Compensating Concrete (2010). Representative examples of shrinkage-compensating cement are found in U.S. Pat. No. 7,988,782, US20150107493 and U.S. Pat. No. 4,419,136.

Expansive cement has also been used in the oil and gas industry to cement wells. Representative examples of this technology are found in U.S. Pat. Nos. 2,465,278, 3,884,710, 4,002,483, 4,797,159, 5,942,031, and 6,966,376. Unfortunately, many cement expansion agents begin hydrating as soon as they contact water and cannot easily be added to the cement slurry mix water. Also, when the expansion agent is added to the slurry, the viscosity and/or yield stress of the slurry increase before the slurry can be placed and set, especially when exposed to increasing temperature conditions, such as are frequently encountered downhole in a well, leading to difficulties in pumping and placement of the slurry, and also complicating job design. Moreover, any hydration of the expanding agent that occurs before the cement sets does not contribute to expansion of the set cement.

Various efforts to delay expansion have been suggested. Coating of metal oxide particles with non-hydratable or previously hydrated minerals such as metal carbonates, hydroxides and hydrates was suggested in U.S. Pat. Nos. 4,332,619, 5,741,357, EP2169027A1; but these materials can be difficult to prepare and have had only limited success.

The cement industry in general is in need of ways to improve the preparation, handling and design of hydraulic cements with hydratable expanding agents that address these problems and shortcomings; and the oil and gas industry is in need of ways to better and more controllably delay hydration of the expanding agents, and to improve the bonding between set cement and the casing.

### SUMMARY

Some embodiments of the present disclosure are directed to delayed-expansion cement mixtures comprising hydrophobically modified expanding agents, and methods for preparing and using such mixtures in general, as well as in well cementing operations. In some embodiments, the delayed-expansion cement mixtures can facilitate preparation and handling and simplify the design of cementing operations. The delayed expansion in some embodiments can radially pre-stress the cement sheath in a wellbore annulus, thereby allowing the cement to maintain zonal isolation and/or an acoustic coupling or other bond with the casing, despite pressure and temperature variations, mechanical perturbations arising from well intervention operations and deposits of drilling fluid or spacer left on the casing surface.

In an aspect, embodiments relate to a delayed-expansion cement mixture. The cement mixture in some embodiments comprises hydraulic cement and hydrophobically modified expanding agent, e.g., hydrophilic particles of cement and a finely-divided, hydratable expanding agent having hydrophobically modified surfaces comprising a hydrophobic film, e.g., a self-assembling monolayer or non-monolayer film. A self-assembling film is one formed spontaneously by adsorption of molecules onto a substrate surface to create a generally organized molecular architecture, which in the various embodiments may be a monolayer or may be a non-monolayer.

In another aspect, embodiments relate to a method to delay expansion of hydraulic cement. In some embodiments, the method comprises treating particles of a hydratable expanding agent with a hydrophobic film precursor compound, e.g., a self-assembling film precursor compound, combining the treated expanding agent with water and particles of hydraulic cement to form a settable cement slurry, hardening the slurry to a set cement, and expanding the set cement.

In some embodiments, the expanding agent is surface-modified with a hydrophobic and/or self-assembling film precursor compound having the structure Y—Z—(CQ₂)ₙ-W—X, wherein Y is H, a halogen, or a hydrophobic moiety having m carbon atoms where m is from 1 to about 40; Z is a covalent bond or an organic linking group having m′ carbon atoms; Q is H or F; n is from 1 to about 40, provided that m+m′+n is from about 6 to about 40; W is a covalent bond or an organic linking group; and X is a moiety having an affinity for the expanding agent. As used herein, “affinity” refers to a tendency of a molecule or moiety to bind or otherwise associate with another moiety, molecule or substance.

In another aspect, embodiments relate to a method to cement a subterranean well having a borehole. In some embodiments, the method comprises mixing particles of hydraulic cement with a finely-divided hydratable expanding agent having hydrophobically modified surfaces; and placing the mixture in a downhole region of the well, such as an annular region of the well between a first tubular body and a borehole wall or a second tubular body. The method then comprises hardening the mixture, e.g., in the downhole region to form a set cement, and hydrating the expanding agent, e.g., to expand the set cement. In some embodiments, an aqueous slurry of the cement and expanding agent is prepared.

In another aspect, embodiments relate to a method to determine the presence of cement behind a tubular body in a subterranean well. In some embodiments, the method comprises: preparing a cement slurry comprising water, particles of hydraulic cement and a finely-divided hydratable expanding agent having hydrophobically modified surfaces comprising hydrophobic film precursor compound, e.g., a self-assembled film; placing the slurry in an annular region of the well between a first tubular body and a borehole wall or a second tubular body; hardening the slurry to form a set cement; expanding the set cement to compress against and bond with the first tubular member; and while maintaining the compression and bond, introducing an acoustic logging tool into the tubular body to measure acoustic impedance, amplitude, attenuation or a bond index or a combination thereof, the measurements taken azimuthally, longitudinally or both along the first tubular body. As used herein, “compression” in the annular region refers to compression in the transverse direction against or between the first tubular member and the borehole wall or second tubular member due to expansion of the cement. As used herein, “bonding” refers to acoustic coupling and/or the formation of a fluid-tight seal.

In another aspect, embodiments relate to a method to maintain zonal isolation in a wellbore. In some embodiments, the method comprises: preparing a cement slurry comprising water, particles of hydraulic cement and a finely-divided hydratable expanding agent having hydrophobically modified surfaces comprising a hydrophobic film, e.g., a self-assembled film; placing the slurry in an annular region of the well between a first tubular body and a borehole wall or a second tubular body; hardening the slurry to form a set cement; expanding the set cement to compress against and bond with the borehole wall to isolate a zone of the formation adjacent the expanded cement; and maintaining the compression and bond adjacent the isolated zone after fluctuating a dimension of the first tubular body in response to a temperature change, a pressure change, or a mechanical disturbance resulting from a well intervention or a combination thereof.

### BRIEF DESCRIPTON OF THE DRAWINGS

FIG. 1 shows a diagram of a well cemented according to embodiments of the disclosure.

FIG. 2 shows a diagram of an annulus between two tubular members cemented according to embodiments of the disclosure.

FIG. 3 shows the isothermal calorimetry curve for hydration of CaO particles untreated and treated with different lipophilic compounds in the examples below according to embodiments of the disclosure.

FIG. 4 shows the cumulative heat flow curve for hydration of CaO particles untreated and treated with 12,12,13,13,14,14,15,15,15-nonafluoropentadecylphosphonic acid in an example below according to embodiments of the disclosure.

### DETAILED DESCRIPTION

The present disclosure will be described in terms of treatment of vertical wells, but is equally applicable to wells of any orientation. As used herein, “transverse” is intended to refer to a direction transverse to the axis of the well, e.g., the horizontal direction in a vertical well and vice versa. The disclosure will be described for hydrocarbon-production wells, but it is to be understood that the disclosed methods can be used for wells for the production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that applicant appreciates and understands that any and all data points within the range are to be considered to have been specified, and that the applicant has possession of the entire range and all points within the range.

As used in the specification and claims, “near” is inclusive of “at.” The term “and/or” refers to both the inclusive “and” case and the exclusive “or” case, whereas the term “and or” refers to the inclusive “and” case only and such terms are used herein for brevity. For example, a component comprising “A and/Or B” may comprise A alone, B alone, or both A and B; and a component comprising “A and or B” may comprise A alone, or both A and B.

A “moiety” refers to a portion of a molecule, e.g., one or a group of more than one atom in a polyatomic molecule. A hydrophobic moiety, compound or surface is one having little or no affinity for water; a hydrophilic moiety, compound or surface is one having a strong affinity for water or otherwise having a tendency to mix with, dissolve in, or be wetted by water. The terms “hydrophilic” and “hydrophobic” in reference to particles refers to the tendency of the exposed surface of the particle for attraction or repulsion of water, respectively. For example, uncoated hydraulic cement or cement particles with a hydrophilic coating are hydrophilic, whereas hydraulic cement particles with a hydrophobic coating are not.

A precursor compound is one that forms or is incorporated into an ultimate or intermediate compound or structure, e.g., by adsorption and/or chemical reaction. The precursor compound may or may not exist in its precursor form as incorporated in the ultimate compound or structure. For convenience and clarity herein, the incorporated compound may be referred to in the ultimate compound or structure by reference to the precursor compound, but it is to be understood that the as-incorporated form is intended.

As used herein, the term “organic group” means a hydrocarbon group such as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” or “alkylene group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” or “alkenylene group” means an unsaturated, linear or branched hydrocarbon group with one or more carbon-carbon double bonds, such as a vinyl group. The term “alkynyl group” or “alkynylene group” means an unsaturated, linear or branched hydrocarbon group with one of more carbon-carbon triple bonds. The term “cyclic group” means a closed ring hydrocarbon group such as an alicyclic group, aromatic group, or heterocyclic group. The term “alicyclic group” means a cyclic hydrocarbon group having properties resembling those of aliphatic groups. The term “aromatic group” or “aryl group” or “arylene group” means a mono- or polynuclear aromatic hydrocarbon group. The term “heterocyclic group” means a closed ring hydrocarbon in which one or more of the atoms in the ring is an element other than carbon (e.g., nitrogen, oxygen, sulfur, etc.).

Any of the foregoing groups may be substituted or unsubstituted When the term “group” is used to describe a chemical substituent, the described chemical material includes the unsubstituted group and that group substituted with O, N, or S atoms, for example, in the chain as well as carbonyl groups or other conventional substitution. For example, the phrase “alkyl group” is intended to include not only pure saturated hydrocarbon alkyl substituents, such as methyl, ethyl, propyl, t-butyl, and the like, but also alkyl substituents bearing further substituents (e.g., functional groups or heteroatoms), such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc.

In this disclosure, the tubular body may be any string of tubulars that may be run into the wellbore and at least partially cemented in place. Examples include casing, liner, solid expandable tubular, production tubing and drill pipe.

In an aspect, embodiments broadly relate to a delayed-expansion cement mixture, comprising hydraulic cement and hydrophobically modified expanding agent. In some embodiments, the cement mixture comprises hydrophilic particles of hydraulic cement and a finely-divided, hydratable expanding agent having hydrophobically modified surfaces. As used herein, “modification” includes any treatment such as contact with a modifying agent, e.g., a hydrophobic film precursor compound, such as a self-assembling film precursor compound. In all aspects, the hydrophobic film may be a self-assembling film, or a self-assembling monolayer film, and the modifying agent may be a hydrophobic film precursor compound, such as a self-assembling monolayer film precursor compound. In all aspects, the self-assembling film may be a self-assembling non-monolayer film and the modifying agent may be a self-assembling non-monolayer film precursor compound.

In some embodiments for all aspects, the cement mixture comprises an aqueous slurry. In some embodiments for all aspects, the slurry comprises the cement particles and from 0.1 to 25 weight percent of the expanding agent, by total weight of the cement particles and the expanding agent (dry basis).

In some embodiments for all aspects, the hydraulic cement particles comprise Portland cement, calcium aluminate cement, fly ash, blast furnace slag, a lime/silica blend, magnesium oxychloride, a geopolymer, zeolite, chemically bonded phosphate ceramic, or the like, or a combination thereof. In some embodiments the hydraulic cement comprises Portland cement. In some embodiments, for all aspects, the hydraulic cement particles may be hydrophobic. In some embodiments, for all aspects, the viscosity of the cement slurry during placement may be lower than 1000 cP at a shear rate of 100 s⁻¹. In some embodiments, for all aspects, the cement mixture or slurry may further comprise silica, diatomaceous earth, gilsonite, hematite, ilmenite, manganese tetraoxide, barite, glass or ceramic microspheres or combinations thereof.

In some embodiments, for all aspects, the cement slurry or other mixture may be essentially free of cement setting retardants, or contain less than 1 weight percent of retardants based on the weight of the cement particles (dry basis), so that, except for the presence of the expanding agent, in all other respects the cement mixture or slurry sets normally. For example, it may not be desirable to delay the setting of the hydraulic cement once it is placed. In some embodiments, the cement mixture may further comprise a setting accelerant.

In some embodiments, for all aspects, the expanding agent comprises a hydratable compound selected from the group consisting of metal oxides and salts, e.g., alkaline earth metal oxides and alkaline earth metal salts. Representative examples of hydratable alkaline earth metal oxides and salts include calcium oxide, magnesium oxide, calcium sulfate hemihydrate, and so on, and combinations thereof.

In some embodiments, the expanding agent is modified with a hydrophobic film precursor compound. In some embodiments, the expanding agent is modified with a self-assembling film precursor compound. In some embodiments, the precursor compound has the structure Y—Z—(CQ₂)ₙ-W—X wherein:
Y is H, a halogen, or a hydrophobic moiety having m carbon atoms where m is from 1 to about 40;
Z is a covalent bond or an organic linking group having m′ carbon atoms;
Q is H or F;
n is from 1 to about 40, provided that m+m′+n is from about 6 to about 40;
W is a covalent bond or an organic linking group; and
X is a moiety having an affinity for the expanding agent.

In some embodiments, Y H, a halogen (fluoro, iodo, chloro, bromo, etc.), or a hydrophobic moiety such as an organic group having from 1 to 40 carbon atoms, or from 1 to 32 carbon atoms, or from 1 to 24 carbon atoms, or from 1 to 20 carbon atoms. In some embodiments, Y is H, F, or a perfluoroalkyl group of the formula (CₘX₂ₘ₊₁) where m is up to about 10.

In some embodiments, Z and W are independently covalent bonds. In some embodiments, Z and W are independently an organic linking group, such as a linear, branched, or cyclic structure that may be saturated or unsaturated, e.g., a linear group that includes heteroatoms and/or functional groups. In some embodiments each divalent Z or W group is independently a linear group that includes heteroatoms and/or functional groups. Examples include a divalent alkylene group, arylene group, or mixture thereof, substituted with one or more heteroatoms (e.g., oxygen, nitrogen, or sulfur), functional groups (e.g., carbonyl, amido, or sulfonamido), or both, containing about 2 to about 16 carbon atoms, or about 3 to about 10 carbon atoms. In some embodiments, structures for Z and W are selected such that they do not inhibit self-assembly.

In some embodiments, X is a moiety that has an affinity for the expanding agent. In some embodiments, X is a moiety that binds to the expanding agent. In some embodiments, X is a thiol group, a monophosphate group, a phosphonate or phosphonic acid group, a hydroxamic acid group, a carboxylic acid group, an isonitrile group, a silyl group, disulfide group, a heterocyclic group such as benzotriazolyl, thiazolyl, benzimidazolyl, or pyridinyl, or the like, and combinations (including mixtures) thereof.

In some embodiments, X is selected from the group consisting of phosphonate, phosphonic acid, halosilyl, alkoxysilyl, and the like, including combinations thereof. In some embodiments, X is phosphonic acid. In some embodiments, X is silyl. In some embodiments, X is halosilyl, e.g., trichlorosilyl. In some embodiments, X is alkoxysilyl, e.g., trialkoxysilyl where the alkoxy groups independently have from 1 to 8 carbon atoms, or from 1 to 4 carbon atoms, e.g., trimethoxysilyl, triethoxysilyl, tri-n-propoxysilyl, tri-isopropoxysilyl, tributoxysilyl, or the like.

In some embodiments, Q is H (hydrogen). In some embodiments, n is from 1 to 40. In some embodiments, Y comprises m carbon atoms and Z comprises m′ carbon atoms, and n+m+m′ is from about 6 to about 40, or from about 6 to about 32, or from about 6 to about 24, or from about 6 to about 20 carbon atoms.

In some embodiments, the expanding agent is surface-modified with a hydrophobic and/or self-assembling film precursor compound having the structure Y—Z—(CQ₂)ₙ-W—X wherein:
Y is H, F, or a perfluoroalkyl group of the formula (CₘX₂ₘ₊₁) where m is up to about 10;
Z is a covalent bond or an organic linking group having m′ carbon atoms;
Q is H or F;
n is from 1 to about 40, provided that n+m+m′ is from about 6 to about 40;
W is a covalent bond or an organic linking group; and
X is a moiety that binds to the expanding agent.

In some embodiments, Y is H, W and Z are covalent bonds, Q is H, and X is selected from the group consisting of phosphonate, phosphonic acid, halosilyl, alkoxysilyl, and combinations thereof. In some embodiments, Y is a perfluoroalkyl group of the formula (CₘX₂ₘ₊₁) where m is up to about 10, W and Z are covalent bonds, Q is H, and X is selected from the group consisting of phosphonate, phosphonic acid, halosilyl, alkoxysilyl, and combinations thereof. In all aspects, the film may be oleophobic as well as hydrophobic, e.g., where Y is an oleophobic and hydrophobic perfluoroalkyl group.

In some embodiments, the expanding agent is surface-modified with an organophosphonic acid compound according to the formula R—P(O)(OH)₂ wherein R is alkyl having from 6 to 32 carbon atoms, e.g., 8 to 24 carbon atoms, or 8 to 20 carbon atoms.

In some embodiments, the expanding agent is surface-modified with a perfluoroalkyl-alkylene-phosphonic acid compound according to the formula (CₘF₂ₘ₊₁)(CH₂)ₙ—P(O)(OH)₂ wherein m+n is from 6 to 32, e.g., from 8 to 24, or from 8 to 20; and m is from 1 to 10. In some embodiments the perfluorinated alkyl end groups CₘX₂ₘ₊₁ further facilitate delaying hydration of the expanding agent.

In some embodiments, representative examples of the precursor compound include n-octyl-phosphonic acid, n-octadecyl-phosphonic acid, (12,12,13,13,14,14,15,15,15-nonafluoropentadecyl)-phosphonic acid, and the like.

In some embodiments, the expanding agent is surface-modified with an organosilane compound according to the formula R—SiX₃ wherein R is alkyl having from 6 to 32 carbon atoms, e.g., from 8 to 24 carbon atoms, or from 8 to 20 carbon atoms; and either each X is halogen, e.g., fluoro, chloro, bromo, or iodo, or alkoxy having up to 4 carbon atoms, e.g., methoxy, ethoxy, n-propoxy, isopropoxy, etc.

In some embodiments, the expanding agent is surface-modified with a perfluoroalkyl-alkenyl-silane compound according to the formula (CₘF₂ₘ₊₁)(CH₂)ₙ—SiX₃ wherein m is from 1 to 10, and m+n is from 6 to 32, e.g., from 8 to 24, or from 8 to 20; and X is halogen, e.g., fluoro, chloro, bromo, or iodo, or alkoxy having up to 4 carbon atoms, e.g., methoxy, ethoxy, n-propoxy, isopropoxy, etc. In some embodiments the perfluorinated alkyl end groups CₘF₂ₘ₊₁ further facilitate delaying hydration.

In some embodiments, representative examples of film precursor compound include n-octyltriethoxysilane, n-octadecyltriethoxysilane, (3,3,4,4,5,5,6,6,7,7,8,8,9,9,10,10,10-heptadecafluorodecyl)-trichlorosilane, and the like.

In some embodiments, the hydrophobic and/or self-assembling film precursor compound may be any such precursor compound disclosed in U.S. Pat. No. 6,743,470 or US 2008/0131709, which are hereby incorporated by reference herein.

In another aspect, embodiments relate to a method to delay expansion of hydraulic cement that comprises treating particles of the hydratable expanding agent with the hydrophobic and/or self-assembling film precursor compound described herein, combining the treated expanding agent with water and the particles of hydraulic cement to form a settable cement slurry, hardening the slurry to a set cement, and expanding the set cement. In some embodiments, the expanding agent particles are treated with a dilute solution of the precursor compound, e.g., under substantially anhydrous conditions, to form a finely-divided hydratable expanding agent having hydrophobically modified surfaces.

In some embodiments of the method, the combination comprises preparing a first aqueous slurry of the treated expanding agent, and then mixing the first slurry with the cement particles to form the settable cement slurry, i.e., the treated expanding agent is added to the mix water. Optionally, the cement particles may be separately mixed with water in a second aqueous slurry, and then the first and second slurries mixed together. In these embodiments, the hydrophobically treated expanding agent can be slurried and stored, pumped, transferred, mixed, etc., as desired, or at least for a period of time during which the hydration thereof is delayed. This can avoid the handling or blending of the dry expanding agent, and can facilitate mixing since the modified expanding agent can now be slurried in the mix water.

In another aspect, embodiments relate to a method to cement a subterranean well having a borehole, comprising (i) mixing cement particles of hydraulic cement with a finely-divided hydratable expanding agent having hydrophobically modified surfaces; (ii) placing the mixture in a downhole region of the well; (iii) hardening the mixture; and (iv) hydrating the expanding agent, e.g., to expand the set cement. In some embodiments, the surfaces of the expanding agent comprise a hydrophobic and/or self-assembling film, e.g., from treatment with a hydrophobic and/or self-assembling film precursor compound, as described above in connection with the cement mixture.

In some embodiments, the method further comprises preparing an aqueous slurry of the cement particles and the expanding agent, placing the slurry in an annular region of the well between a first tubular body and a borehole wall or a second tubular body, and transversely compressing the set cement between the first tubular body and the borehole wall or second tubular body to maintain bonding therewith.

In some embodiments, the surfaces of the expanding agent comprise a hydrophobic and/or self-assembling film, the expanding agent comprises a hydratable compound selected from the group consisting of alkaline earth metal oxides and alkaline earth metal salts, the cement particles comprise Portland cement, calcium aluminate cement, fly ash, blast furnace slag, a lime/silica blend, magnesium oxychloride, a geopolymer, zeolite, chemically bonded phosphate ceramic, or a combination thereof, and/or the slurry comprises from 0.1 to 25 weight percent of the expanding agent, by total weight of the cement particles and the expanding agent.

In some embodiments, the method further comprises maintaining the bond between the first tubular body and the set cement while measuring an acoustic impedance, an amplitude, an attenuation, or a bond index, or a combination thereof; and/or maintaining the bond between the first tubular body and the set cement, after fluctuating the dimensions of the first tubular body in response to a temperature change, a pressure change, or a mechanical disturbance resulting from a well intervention, or a combination thereof.

In some embodiments, the method further comprises maintaining the bond between the borehole wall and the set cement to isolate a zone of the formation adjacent the expanded cement; and/or maintaining the bond between the borehole wall and the set cement, after fluctuating the dimensions of the first tubular body in response to a temperature change, a pressure change, or a mechanical disturbance resulting from a well intervention, or a combination thereof.

In some embodiments, the method further comprises maintaining the bond between the first tubular body and the set cement, and the bond between the set cement and the borehole wall or the second tubular body, after fluctuating the dimensions of the first tubular body in response to a temperature change, a pressure change, or a mechanical disturbance resulting from a well intervention, or a combination thereof.

In some embodiments, the method further comprises (v) mixing the cement particles and from 0.1 to 25 weight percent of the expanding agent, by total weight of the cement particles and the expanding agent, in water to form an aqueous slurry; and (vi) placing the slurry in an annular region of the well between a first tubular body and a borehole wall or a second tubular body. In some embodiments, the cement particles may comprise Portland cement and/or the expanding agent may comprise a hydratable compound selected from the group consisting of alkaline earth metal oxides and alkaline earth metal salts, e.g., calcium oxide, magnesium oxide, calcium sulfate hemihydrate, and the like.

In some embodiments, the method further comprises (v) preparing an aqueous slurry of the mixture of the cement particles and the expanding agent; (vi) placing the slurry in an annular region of the well between a first tubular body and a borehole wall or a second tubular body; and (vii) transversely compressing the set cement between the first tubular body and the borehole wall or second tubular body to maintain bonding therewith. In some embodiments, the cement particles may comprise Portland cement and/or the expanding agent may comprise a hydratable compound selected from the group consisting of alkaline earth metal oxides and alkaline earth metal salts, e.g., calcium oxide, magnesium oxide, calcium sulfate hemihydrate, and the like.

In another aspect, embodiments relate to a method to determine the presence of cement behind a tubular body in a subterranean well comprising: preparing a cement slurry comprising water, particles of hydraulic cement and a finely-divided hydratable expanding agent having hydrophobically modified surfaces, e.g., wherein the expanding agent is selected from the group consisting of calcium oxide, magnesium oxide, calcium sulfate hemihydrate, and so on, and combinations thereof; placing the slurry in an annular region of the well between a first tubular body and a borehole wall or a second tubular body; hardening the slurry to form a set cement; expanding the set cement to compress against and bond with the first tubular member; and while maintaining the compression and bond, introducing an acoustic logging tool into the tubular body to measure acoustic impedance, amplitude, attenuation or a bond index or a combination thereof, the measurements taken azimuthally, longitudinally or both along the first tubular body.

In another aspect, embodiments relate to a method to maintain zonal isolation in a wellbore comprising: preparing a cement slurry comprising water, particles of hydraulic cement and a finely-divided hydratable expanding agent having hydrophobically modified surfaces, e.g., wherein the expanding agent is selected from the group consisting of calcium oxide, magnesium oxide, calcium sulfate hemihydrate, and so on, and combinations thereof; placing the slurry in an annular region of the well between a first tubular body and a borehole wall or a second tubular body; hardening the slurry to form a set cement; expanding the set cement to compress against and bond with the borehole wall to isolate a zone of the formation adjacent the expanded cement; and maintaining the compression and bond adjacent the isolated zone after fluctuating a dimension of the first tubular body in response to a temperature change, a pressure change, or a mechanical disturbance resulting from a well intervention or a combination thereof.

In some embodiments, the expansion of the expanding agent exposes non-hydrophobically modified surfaces of the expanding agent and thereby accelerates further hydration of the expanding agent. In some embodiments, hydration of the expanding agent expands the set cement to a state of compression within the annular region and facilitates maintenance of a bond with the first tubular member and the borehole wall or second tubular member.

The method may further comprise fluctuating the dimensions of the first tubular body, e.g., allowing the dimensions of the tubular body to fluctuate in response to a temperature change, a pressure change, or a mechanical disturbance resulting from a well intervention or a combination thereof. The method may also further comprise transversely compressing the set cement between the first tubular body and the borehole wall or second tubular body to maintain bonding therewith, e.g., allowing the set cement to expand and/or to maintain the state of compression, during and/or after the dimensional fluctuation of the first tubular body.

For all aspects, the cement expansion may be delayed, e.g., by delaying hydration of the expanding agent. In some embodiments, the hydrophobic modification of the expanding agent inhibits water infiltration, and thereby delays hydration of the expanding agent to delay the expansion of the set cement.

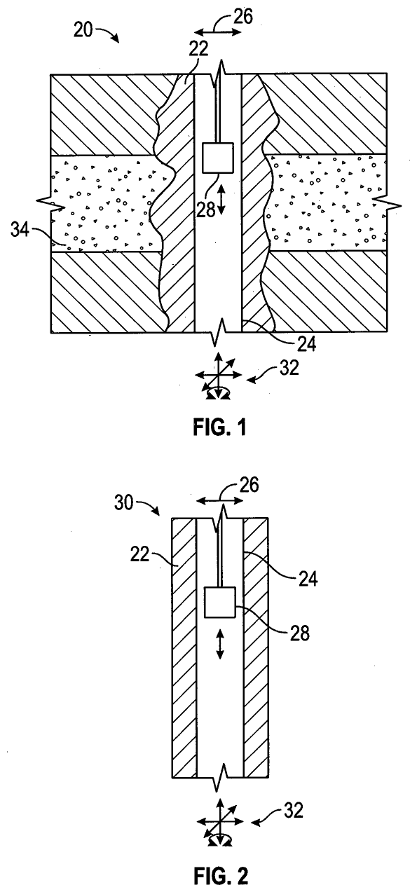

With reference to embodiments of the borehole 20 and tubular member 30 shown in FIGS. 1 and 2, wherein like numerals are used to designate like parts, the cement comprising the encapsulated expanding agent is placed in the annulus 22 around the tubular member 24, set in place, and with hydration of the expanding agent, expanded as indicated at 26 to induce a state of compression and facilitate bonding. The annulus 22 is shown between the tubular member 24 and the wellbore 20 (FIG. 1) or the tubular member 30 (FIG. 2). The logging tool 28 is then introduced to take measurements as described in some embodiments herein, for example, to map impedance and determine the presence of cement in the annulus 22 behind the tubular member 24, or the absence thereof suggesting formation of a microannulus (not shown) between the tubular member 24 and the set cement in the annulus 22.

The tubular member 24 in FIGS. 1 and 2 (and/or tubular member 30 in FIG. 2) may be dimensionally changed in length, diameter, rotational alignment, etc., e.g., with respect to the wellbore 20 (FIG. 1) or the tubular member 30 (FIG. 2), some examples of which are indicated at 32. Expansion 26 of the cement set in the annulus 22 can occur before the dimensional change 32, and according to some embodiments of the disclosure, the state of compression of the cement is maintained in the annulus 22 during and/or after the dimensional change 32, e.g., by further expansion or increased compression to accommodate the changing dimension(s). Expansion 26 of the cement set in the annulus 22 can instead and/or also occur during and/or after the dimensional change 32, and according to some embodiments of the disclosure, the state of compression of the cement can be induced in the annulus 22 during and/or after the dimensional change 32.

With reference to FIG. 1, in some embodiments a zone 34 is isolated by placement, setting, and expansion 26 of the cement in the annulus 22. The compression and bonding can be maintained during dimensional change 32, e.g., so that the zone 34 remains in isolation and does not fluidly communicate via the annulus 22 with other zones in the formation.

Activation of a surface-modified expanding agent over time may be brought about by means of a hydrophobic compound which attaches to the surface of the expanding agent particles and inhibits the mass transfer of water into the expanding agent particle and thus delays hydration of the expanding agent until the cement slurry is placed in the location where it is to be set and/or until the cement slurry has at least begun to set.

Hydrophobic modification of the expanding agent can be achieved by contacting the expanding agent with the precursor compound, which may be under conditions and for a period of time to impart a hydrophobic character to the expanding agent, such as is reflected in a delayed hydration rate. Procedures and techniques for modifying metal oxides with self-assembling monolayer compounds are disclosed, for example, in Jin, J. et al., Analytica Chimica Acta, vol. 693, pp. 54-61 (2011).

In some embodiments, before modification the expanding agent may optionally be heated to remove water and/or hydrates, e.g., above 100° C. or above 200° C., and/or calcined at higher temperatures, e.g., above 400° C. or above 600° C. up to 1000° C. or up to 1200° C., or up to 1500° C., or up to 2000° C. In some embodiments, particles of the expanding agent, generally from 0.1 to 500 microns, e.g., from 1 to 100 microns, are then slurried in a solution of the precursor compound, e.g., a dilute or concentrated solution such as from 1 mM up to 1 M or more, for a period of time and at conditions suitable for the precursor compound to attach to surfaces of the expanding agent. The modified particles can be recovered by filtration or centrifugation to remove excess solution and drying to remove any remaining solvent. In another embodiment, the expanding agent particles can be contacted with a vapor comprising the precursor compound. The modification can be done under essentially anhydrous conditions to avoid hydrating the expanding agent, e.g., by using anhydrous solvent(s) and precursor compound solutions.

In some embodiments, although the rates of hydration of the modified expanding agent, and expansion of the cement, may be predicted, the hydration and expansion profiles can also be observed in laboratory experiments before the particles are used. Such experiments involve exposing a sample quantity of the modified expanding agent, or a cement slurry of particles of the cement and modified expanding agent, to water and other conditions which match those found in the borehole location, and monitoring hydration of the expanding agent over time, and/or formulating the cement slurry with the modified expanding agent and monitoring the expansion of the set cement upon exposure to the matching borehole conditions.

### Embodiments Listing

In accordance with the foregoing description, the present disclosure is exemplified by the following embodiments:
1. A delayed-expansion cement mixture comprising:
   particles of hydraulic cement; and
   a finely-divided, hydratable expanding agent having hydrophobically modified surfaces.
2. The cement mixture according to Embodiment 1, wherein the cement particles are hydrophilic.
3. The cement mixture according to Embodiment 1 or Embodiment 2, wherein the surfaces comprise a hydrophobic film.
4. The cement mixture according to any one of Embodiments 1 to 3, wherein the surfaces comprise a self-assembling film.
5. The cement mixture according to any one of Embodiments 1 to 4, wherein the surfaces comprise a self-assembling monolayer film.
6. The cement mixture according to any one of Embodiments 1 to 4, wherein the surfaces comprise a self-assembling non-monolayer film.
7. The cement mixture according to any one of Embodiments 1 to 6, wherein the expanding agent is surface-modified with a film precursor compound having the structure Y—Z—(CQ₂)ₙ-W—X wherein:
   Y is H (hydrogen), a halogen, or a hydrophobic moiety having m carbon atoms where m is from 1 to about 40;
   Z is a covalent bond or an organic linking group having m′ carbon atoms;
   Q is H or F;
   n is from 1 to about 40, provided that m+m′+n is from about 6 to about 40;
   W is a covalent bond or an organic linking group; and
   X is a moiety having an affinity for the expanding agent.
8. The cement mixture according to Embodiment 7, wherein Y is H, F, or a perfluoroalkyl group of the formula (CₘX₂ₘ₊₁) where m is up to about 10.
9. The cement mixture according to Embodiment 7 or Embodiment 8, wherein Z and W are covalent bonds.
10. The cement mixture according to any one of Embodiments 7 to 9, wherein Q is H.
11. The cement mixture according to any one of Embodiments 7 to 10, wherein n+m+m′, is from about 6 to about 40, or from about 6 to about 32, or from about 6 to about 24, or from about 6 to about 20 carbon atoms.
12. The cement mixture according to any one of Embodiments 7 to 11, wherein X binds to the expanding agent.
13. The cement mixture according to any one of the Embodiments 7 to 12, wherein X is selected from the groups consisting of a thiol group, a monophosphate group, a phosphonate or phosphonic acid group, a hydroxamic acid group, a carboxylic acid group, an isonitrile group, a silyl group, a disulfide group, a heterocyclic group (such as benzotriazolyl, thiazolyl, benzimidazolyl, or pyridinyl), and combinations thereof.
14. The cement mixture according to any one of the Embodiments 7 to 12, wherein X is selected from the group consisting of phosphonate, phosphonic acid, halosilyl, alkoxysilyl, and combinations thereof.
15. The cement mixture according to any one of the Embodiments 7 to 12, wherein X is phosphonic acid.
16. The cement mixture according to any one of the Embodiments 7 to 12, wherein X is silyl.
17. The cement mixture according to any one of the Embodiments 7 to 12, wherein X is halosilyl, or trichlorosilyl.
18. The cement mixture according to any one of Embodiments 7 to 12, wherein X is alkoxysilyl, or X is trialkoxysilyl where the alkoxy groups independently have from 1 to 8 carbon atoms, or from 1 to 4 carbon atoms, or X is selected from the group consisting of trimethoxysilyl, triethoxysilyl, tri-n-propoxysilyl, tri-isopropoxysilyl, tributoxysilyl, or combinations thereof.
19. The cement mixture according to any one of Embodiments 1 to 18, wherein the expanding agent is surface-modified with an organophosphonic acid compound according to the formula R—P(O)(OH)₂ wherein R is alkyl having from 6 to 32 carbon atoms, or 8 to 24 carbon atoms, or 8 to 20 carbon atoms.
20. The cement mixture according to any one of Embodiments 1 to 18, wherein the expanding agent is surface-modified with n-octyl-phosphonic acid, n-octadecyl-phosphonic acid, or (12,12,13,13,14,14,15,15,15-nonafluoropentadecyl)-phosphonic acid.
21. The cement mixture according to any one of Embodiments 1 to 18, wherein the expanding agent is surface-modified with an organosilane compound according to the formula R—SiX′₃ wherein R is alkyl having from 6 to 32 carbon atoms, or from 8 to 24 carbon atoms, or from 8 to 20 carbon atoms; and X′ is halogen (or fluoro, chloro, bromo, or iodo), or alkoxy having up to 4 carbon atoms (or methoxy, ethoxy, n-propoxy, or isopropoxy).
22. The cement mixture according to any one of Embodiments 1 to 18, wherein the expanding agent is surface-modified with a perfluoroalkyl-alkenyl-silane compound according to the formula (CₘF₂ₘ₊₁)(CH₂)ₙ—SiX′₃ wherein m is from 1 to 10; m+n is from 6 to 32, or from 8 to 24, or from 8 to 20; and X′ is halogen (or fluoro, chloro, bromo, or iodo), or alkoxy having up to 4 carbon atoms (or methoxy, ethoxy, n-propoxy, or isopropoxy).
23. The cement mixture according to any one of Embodiments 1 to 18, wherein the expanding agent is surface-modified with n-octyltriethoxysilane, n-octadecyltriethoxysilane, or (3,3,4,4,5,5,6,6,7,7,8,8,9,9,10,10,10-heptadecafluorodecyl)-trichlorosilane.
24. The cement mixture according to any one of Embodiments 1 to 23, comprising an aqueous slurry comprising the cement particles and the expanding agent.
25. The cement mixture according to Embodiment 24, comprising from 0.1 to 25 weight percent of the expanding agent, by total weight of the cement particles and the expanding agent.
26. The cement mixture according to any one of Embodiments 1 to 25, wherein the expanding agent comprises a hydratable compound selected from the group consisting of alkaline earth metal oxides and alkaline earth metal salts.
27. The cement mixture according to any one of Embodiments 1 to 26, wherein the expanding agent comprises CaO, MgO, calcium sulfate hemihydrate, or a combination thereof.
28. The cement mixture according to any one of Embodiments 1 to 27, wherein the hydraulic cement particles have hydrophilic surfaces and/or comprise Portland cement, calcium aluminate cement, fly ash, blast furnace slag, a lime/silica blend, magnesium oxychloride, a geopolymer, zeolite, chemically bonded phosphate ceramic, or a combination thereof.
A1. A method to delay expansion of hydraulic cement, comprising:
   treating particles of a hydratable expanding agent with a hydrophobic film precursor compound to form a finely-divided hydratable expanding agent having hydrophobically modified surfaces;
   combining the treated expanding agent with water and particles of hydraulic cement to form a settable cement slurry;
   hardening the slurry to a set cement; and
   expanding the set cement.
A2. The method according to Embodiment A1, wherein the settable cement slurry comprises the cement mixture according to any one of Embodiments 1 to 28.
A3. A method to cement a subterranean well having a borehole, comprising:
   (i) mixing particles of hydraulic cement with a finely-divided hydratable expanding agent having hydrophobically modified surfaces;
   (ii) placing the mixture in a downhole region of the well;
   (iii) hardening the mixture to form a set cement; and
   (iv) hydrating the expanding agent to expand the set cement.
A4. The method according to Embodiment A3, wherein the mixture comprises the cement mixture according to any one of Embodiments 1 to 28.
A5. The method according to Embodiment A2 or Embodiment A4, wherein the cement mixture comprises the cement mixture according to Embodiment 7.
A6. The method according to Embodiment A2 or Embodiment A4, wherein the cement mixture is according to Embodiment 8.
A7. The method according to Embodiment A6, the cement mixture is according to Embodiment 14.
A8. The method according to Embodiment A6, wherein the cement mixture is according to Embodiment 19.
A9. The method according to Embodiment A6, wherein the cement mixture is according to Embodiment 20.
A10. The method according to Embodiment A6, wherein the cement mixture is according to Embodiment 21.
A11. The method according to Embodiment A6, wherein the cement mixture is according to Embodiment 22.
A12. The method according to Embodiment A6, wherein the cement mixture is according to Embodiment 23.
A13. The method according to Embodiment A3 or Embodiment A4, further comprising:
   preparing an aqueous slurry of the cement particles and the expanding agent;
   placing the slurry in an annular region of the well between a first tubular body and a borehole wall or a second tubular body; and
   transversely compressing the set cement between the first tubular body and the borehole wall or second tubular body to maintain bonding therewith.
A14. The method according to Embodiment A13, wherein:
   the surfaces of the expanding agent comprise a self-assembling film;
   the expanding agent comprises a hydratable compound selected from the group consisting of alkaline earth metal oxides and alkaline earth metal salts;
   the cement particles comprise Portland cement, calcium aluminate cement, fly ash, blast furnace slag, a lime/silica blend, magnesium oxychloride, a geopolymer, zeolite, chemically bonded phosphate ceramic, or a combination thereof; and
   the slurry comprises from 0.1 to 25 weight percent of the expanding agent, by total weight of the cement particles and the expanding agent.
A15. The method according to Embodiment A13 or Embodiment A14, further comprising maintaining the bond between the first tubular body and the set cement while measuring an acoustic impedance, an amplitude, an attenuation, or a bond index, or a combination thereof.
A16. The method according to any one of Embodiments A13 to A15, further comprising maintaining the bond between the first tubular body and the set cement, after fluctuating the dimensions of the first tubular body in response to a temperature change, a pressure change, or a mechanical disturbance resulting from a well intervention, or a combination thereof.
A17. The method according to any one of Embodiments A13 to A16, further comprising maintaining the bond between the borehole wall and the set cement to isolate a zone of the formation adjacent the expanded cement.
A18. The method according to any one of Embodiments A13 to A17, further comprising maintaining the bond between the borehole wall and the set cement, after fluctuating the dimensions of the first tubular body in response to a temperature change, a pressure change, or a mechanical disturbance resulting from a well intervention, or a combination thereof.

### EXAMPLES

The following examples are provided to more fully illustrate the disclosure. These examples are not intended to limit the scope of the disclosure in any way.

Pre-calcined CaO particles were modified with the organophosphonic acid and organosilane compounds listed in Table 1 below. To treat the particles with the organophosphonic acid compounds, 0.01 M solutions of the treating compound in 99 wt % ethanol were prepared. To treat the particles with the organosilane compounds, 0.01 M solutions of the treating compound in trichloroethylene were prepared. The CaO particles were mixed into the solutions, and the reaction was allowed to proceed for 24 h at ambient temperature. The treated particles were recovered by filtration and dried in an oven for 3 h, at 100° C. to remove ethanol or at 150° C. to remove trichloroethylene.

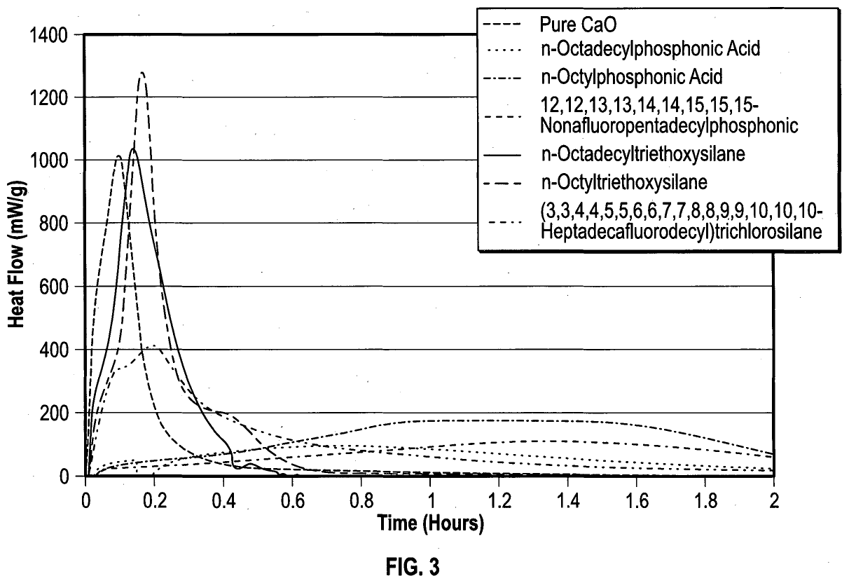

The treated particles were mixed with water and placed in a differential scanning calorimeter (DSC) to observe the isothermal hydration calorimetry profile at 30° C. Hydration was followed by measuring the heat generated by the exothermic hydration reaction CaO+H₂O→Ca(OH)₂. The DSC heat flow curves are shown in FIG. 3.

The maximum heat flow peak was indicated when the hydration rate was at its maximum. A comparison of the peak heat flow times is also given in Table 1.

TABLE 1
Peak hydration times for modified CaO at 30° C.

| Lipophilic grafting agent | Time to peak (min) |
|---|---|
| None (unmodified) | 6 |
| n-Octadecylphosphonic acid | 46 |
| n-Octylphosphonic acid | 62 |
| 12,12,13,13,14,14,15,15,15-Nonafluoropentadecyl | 80 |
| phosphonic acid | |
| n-Octadecyltriethoxysilane | 8 |
| n-Octyltriethoxysilane | 10 |
| (3,3,4,4,5,5,6,6,7,7,8,8,9,9,10,10,10- | 12 |
| heptadecafluorodecyl)trichlorosilane | |

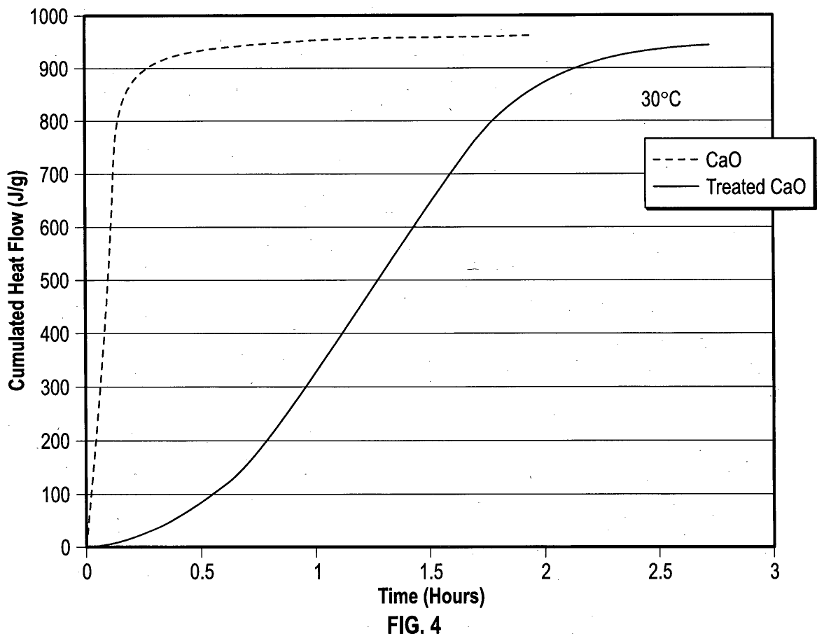

As seen in Table 1 and FIG. 3, of the grafting agents listed, CaO modified with 12,12,13,13,14,14,15,15,15-nonafluoropentadecyl phosphonic acid had the longest time to peak hydration, 80 minutes. The corresponding cumulative heat flow is shown against unmodified CaO in FIG. 4 as a semi-quantitative indication of the expected modification of the expansion profile.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A delayed-expansion cement mixture comprising:
particles of hydraulic cement; and
a finely-divided, hydratable expanding agent having hydrophobically modified surfaces comprising a hydrophobic film.

2. The cement mixture according to claim 1 comprising an aqueous slurry comprising the cement particles and from 0.1 to 25 weight percent of the expanding agent, by total weight of the cement particles and the expanding agent.

3. The cement mixture according to claim 1, wherein the expanding agent comprises a hydratable compound selected from the group consisting of alkaline earth metal oxides and alkaline earth metal salts.

4. The cement mixture according to claim 1, wherein the hydraulic cement particles have hydrophilic surfaces and comprise Portland cement, calcium aluminate cement, fly ash, blast furnace slag, a lime/silica blend, magnesium oxychloride, a geopolymer, zeolite, chemically bonded phosphate ceramic, or a combination thereof.

5. The cement mixture according to claim 1, wherein the expanding agent is surface-modified with a hydrophobic film precursor compound having the structure Y—Z—(CQ₂)ₙ-W—X, wherein:
Y is H, a halogen, or a hydrophobic moiety having m carbon atoms where m is from 1 to 40;
Z is a covalent bond or an organic linking group having m′ carbon atoms;
Q is H or F;
n is from 1 to 40, provided that m+m′+n is from 6 to 40;
W is a covalent bond or an organic linking group; and
X is a moiety having an affinity for the expanding agent.

6. The cement mixture according to claim 5, wherein Y is H, F, or a perfluoroalkyl group of the formula (CₘX₂ₘ₊₁) where m is up to 10.

7. The cement mixture according to claim 5, wherein X is selected from the group consisting of phosphonate, phosphonic acid, halosilyl, alkoxysilyl, and combinations thereof.

8. The cement mixture according to claim 1, wherein the expanding agent is surface-modified with an organophosphonic acid compound according to the formula R—P(O)(OH)₂ wherein R is alkyl having from 6 to 32 carbon atoms.

9. The cement mixture according to claim 1, wherein the expanding agent is surface-modified with a perfluoroalkyl-alkylene-phosphonic acid compound according to the formula (CₘF₂ₘ₊₁)(CH₂)ₙ—P(O)(OH)₂ wherein m is from 1 to 10, and m+n is from 6 to 32.

10. The cement mixture according to claim 1, wherein the expanding agent is surface-modified with an organosilane compound according to the formula R—SiX₃ wherein R is alkyl having from 6 to 32 carbon atoms and X is halogen or alkoxy having up to 4 carbon atoms.

11. The cement mixture according to claim 1, wherein the expanding agent is surface-modified with a perfluoroalkyl-alkenyl-silane compound according to the formula (CₘF₂ₘ₊₁)(CH₂)ₙ—SiX₃ wherein m is from 1 to 10, m+n is from 6 to 32, and X is halogen or alkoxy having up to 4 carbon atoms.

12. A method to delay expansion of hydraulic cement, comprising:
treating particles of a hydratable expanding agent with a hydrophobic film precursor compound to form a finely-divided hydratable expanding agent having hydrophobically modified surfaces;
combining the treated expanding agent with water and particles of hydraulic cement to form a settable cement slurry comprising the cement mixture comprising particles of hydraulic cement; and a finely-divided, hydratable expanding agent having hydrophobically modified surfaces comprising a hydrophobic film;
hardening the slurry to a set cement; and
expanding the set cement.

13. A method to cement a subterranean well having a borehole, comprising:
(i) mixing particles of hydraulic cement with a finely-divided hydratable expanding agent having hydrophobically modified surfaces to form the cement mixture;
(ii) placing the cement mixture in a downhole region of the well;
(iii) hardening the cement mixture to form a set cement; and
(iv) hydrating the expanding agent to expand the set cement.

14. The method according to claim 13, further comprising:
placing the cement mixture in an annular region of the well between a first tubular body and a borehole wall or a second tubular body; and
transversely compressing the set cement between the first tubular body and the borehole wall or second tubular body to maintain bonding therewith.

15. The method according to claim 14, further comprising maintaining the bond between the first tubular body and the set cement while measuring an acoustic impedance, an amplitude, an attenuation, or a bond index, or a combination thereof.

16. (canceled)

17. The method according to claim 14, further comprising maintaining the bond between the borehole wall and the set cement to isolate a zone of the formation adjacent the expanded cement.

18. The method according to claim 15, further comprising maintaining the bond between the borehole wall and the set cement, after fluctuating the dimensions of the first tubular body in response to a temperature change, a pressure change, or a mechanical disturbance resulting from a well intervention, or a combination thereof.
